(19) United States
(12) Patent Application Publication
(10) Pub. No.: US 2026/0330561 A1
(43) Pub. Date: Oct. 22, 2026

(54) CONTEXT-BASED AUTOMATED ASSET MANAGEMENT AND MAINTENANCE

(71) Applicant: MOAT SYSTEMS, INC., Lehi, UT (US)

(72) Inventors: Mikel Xabier Chertudi, American Fork, UT (US); Craig Anderson Hobson, Lehi, UT (US); Jason James Etherington, Taylor, UT (US)

(21) Appl. No.: 19/654,263

(22) Filed: Apr. 21, 2026

Related U.S. Application Data
(60) Provisional application No. 63/792,232, filed on Apr. 21, 2025.

(51) Int. Cl. G06Q 40/06; G06Q 30/012

(52) U.S. Cl. CPC G06Q 40/067; G06Q 30/012

(57) ABSTRACT

A computer-implemented method, computer program product, and a computer system for context-based asset management is provided. The disclosed embodiment includes monitoring a plurality of assets for compliance with asset related documentation and detecting a change to one or more assets of the plurality of assets that deviate from parameters associated with the asset related documentation. In response to detecting a change to one or more assets of the plurality of assets that deviate from parameters associated with the asset related documentation, the disclosed embodiment further includes determining options for respective assets of the plurality of assets based on the detected change and causing at least one asset of the plurality of assets to change its operational behavior or performing physical maintenance on the at least one asset of the plurality of assets based on the detected change and an analysis of the asset related documentation.

### TECHNICAL FIELD

The present disclosure relates generally to information management systems. In particular, some aspects of the disclosure may relate to systems for automated processing and management of assets using Large Language Models (LLMs).

### DESCRIPTION OF RELATED ART

Management of asset warranties and maintenance documentation presents a significant challenge. Organizations maintain a wide array of assets, each with specific warranty terms and maintenance schedules. Traditionally, managing this documentation involves manual processes, which can be error-prone, time-consuming, and costly. As assets increase in complexity and volume, the inefficiencies associated with manual management become more pronounced, leading to potential compliance issues and increased operational risks.

Historically, documentation related to asset warranties and maintenance has been stored in various formats, including paper records, spreadsheets, and disparate databases. This fragmented approach often results in data silos, where critical information is neither easily accessible nor integrated across an organization. Such limitations hinder the ability to make informed decisions regarding asset utilization, maintenance scheduling, and warranty claims.

Conventional solutions to improve document management typically involve digitizing paper records and implementing centralized databases to store and manage information. While these approaches have improved accessibility and organization, they lack the capabilities required to fully automate and optimize the processing and management of complex asset documentation. Large Language Models (LLMs) provide additional capabilities to understand and process human language with high accuracy, enabling automation of documentation tasks that were previously labor-intensive and prone to error.

Despite the potential of LLMs, the application of such technology to the domain of asset warranty and maintenance documentation presents unique challenges. These include accurately interpreting diverse document formats, extracting relevant information from disparate sources, and ensuring compliance with industry-specific regulations and standards.

### BRIEF SUMMARY OF THE DISCLOSURE

Aspects of the present disclosure provide a computer-implemented method for context-based asset management. In some embodiments, the computer-implemented method includes monitoring a plurality of assets for compliance with asset related documentation. The computer-implemented method may further include detecting a change to one or more assets of the plurality of assets that deviate from parameters associated with the asset related documentation. The computer-implemented method may further include in response to detecting a change to one or more assets of the plurality of assets that deviate from parameters associated with the asset related documentation, determining options for respective assets of the plurality of assets based on the detected change. The computer-implemented method may further include causing at least one asset of the plurality of assets to change its operational behavior or performing physical maintenance on at least one asset of the plurality of assets based on the detected change and an analysis of the asset related documentation.

Aspects of the present disclosure further provide a computer program product for context-based asset management. In this embodiment, a computer program product includes one or more processors and one or more computer readable storage media that when executed by the one or more processors, cause program instructions stored on the one or more computer readable storage media to monitor a plurality of assets for compliance with asset related documentation, detect a change to one or more assets of the plurality of assets that deviate from parameters associated with the asset related documentation, in response to detecting a change to one or more assets of the plurality of assets that deviate from parameters associated with the asset related documentation, determine options for respective assets of the plurality of assets based on the detected change, and cause at least one asset of the plurality of assets to change its operational behavior or perform physical maintenance on the at least one asset of the plurality of assets based on the detected change and an analysis of the asset related documentation.

Aspects of the present disclosure further provide a computer system for context-based asset management. In this embodiment, a computer system includes one or more processors, one or more computer readable storage media, and program instructions stored on the one or more computer readable storage media that when executed by the one or more processors, cause the program instructions to monitor a plurality of assets for compliance with asset related documentation, detect a change to one or more assets of the plurality of assets that deviate from parameters associated with the asset related documentation, in response to detecting a change to one or more assets of the plurality of assets that deviate from parameters associated with the asset related documentation, determine options for respective assets of the plurality of assets based on the detected change, and cause at least one asset of the plurality of assets to change its operational behavior or perform physical maintenance on the at least one asset of the plurality of assets based on the detected change and an analysis of the asset related documentation.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto and their equivalents thereof.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a functional block diagram illustrating a computing environment, in accordance with various embodiments of the systems and methods disclosed herein.

FIG. 2 is a flowchart depicting an example of operational steps for context based asset management, in accordance with various embodiments of the systems and methods disclosed herein.

FIG. 3 is a flowchart depicting an example of operational steps for asset management, in accordance with various embodiments of the systems and methods disclosed herein.

FIG. 4A is an example diagram showing a graphical user interface configured to display a managed-assets dashboard, in accordance with various embodiments of the systems and methods disclosed herein.

FIG. 4B is an example graphical user interface configured to display an asset and task tracking interface, in accordance with various embodiments of the systems and methods disclosed herein.

FIG. 4C is an example graphical user interface configured to display a warranty tracking interface, in accordance with various embodiments of the systems and methods disclosed herein.

FIG. 4D is an example diagram showing a graphical user interface configured to display a details interface, in accordance with various embodiments of the systems and methods disclosed herein.

FIG. 4E is an example diagram showing a graphical user interface configured to display a reporting and analytics interface, in accordance with various embodiments of the systems and methods disclosed herein.

FIG. 4F is an example diagram showing a graphical user interface configured to display administrative settings, in accordance with various embodiments of the systems and methods disclosed herein.

FIG. 5 depicts a block diagram of components of the computing systems of FIG. 1, in accordance with various embodiments of the systems and methods disclosed herein.

FIG. 6 depicts a block diagram illustrating an alternate computing environment, in accordance with various embodiments of the systems and methods disclosed herein.

FIGS. 7A, 7B, and 7C represent an example diagram showing a graphical user interface configured to display a mobile scanning workflow for capturing manufacturer equipment placard information in accordance with various embodiments of the systems and methods disclosed herein.

FIG. 8 is an example screenshot showing a graphical user interface configured to display an assignment board, in accordance with various embodiments of the systems and methods disclosed herein.

FIG. 9 is an example screenshot showing a fixed asset analysis, in accordance with various embodiments of the systems and methods disclosed herein.

FIG. 10 is an example screenshot showing a preventive maintenance user interface, in accordance with various embodiments of the systems and methods disclosed herein.

### DETAILED DESCRIPTION

The present disclosure addresses various challenges associated with the management of assets, particularly focusing on automated processing and management of assets using Large Language Models (LLMs). Current asset management systems face significant technical challenges, particularly in handling the diverse and unstructured nature of warranty and maintenance documentation. These systems often rely on manual data entry and human oversight, which can lead to errors, inconsistencies, and inefficiencies. Traditional systems struggle to process documents that vary widely in format and terminology, hindering the accurate extraction and standardization of critical information. This lack of standardization impairs the ability to automate subsequent processes, such as maintenance scheduling and warranty claims, resulting in operational delays and increased costs. Recognizing these technical deficiencies, embodiments of the systems and methods disclosed herein may be implemented to provide technical solutions that integrate LLMs into asset management systems to increase accuracy of these systems. By analyzing standardized data, the disclosed system and methods can automatically create alerts for upcoming maintenance activities. This ensures timely execution, thereby reducing the risk of asset downtime and extending the lifespan of the assets. Additionally, the systems and methods disclosed herein can complete warranty claims by accurately populating required fields based on extracted data, streamlining the claims process and reducing administrative burden.

Beyond maintenance notifications and warranty embodiments of the systems and methods disclosed herein may be integrated into one or more other systems which enable certain embodiments of the systems and methods to automatically order for parts for assets that are nearing the end of their lifecycle or have been flagged for replacement. In some aspects, the disclosed systems and methods can be integrated into a calendaring system that can populate calendar entries to schedule maintenance. In other examples, the disclosed systems and methods can schedule maintenance for a physical asset. In yet other examples, the disclosed systems and methods can be integrated into computer aided design and building information modeling platforms to change and/or monitor design specifications. Furthermore, aspects of the systems and methods may be implemented to initiate automatic maintenance procedures or adjust the operation of assets to ensure compliance with regulatory standards, thereby enhancing operational safety and efficiency.

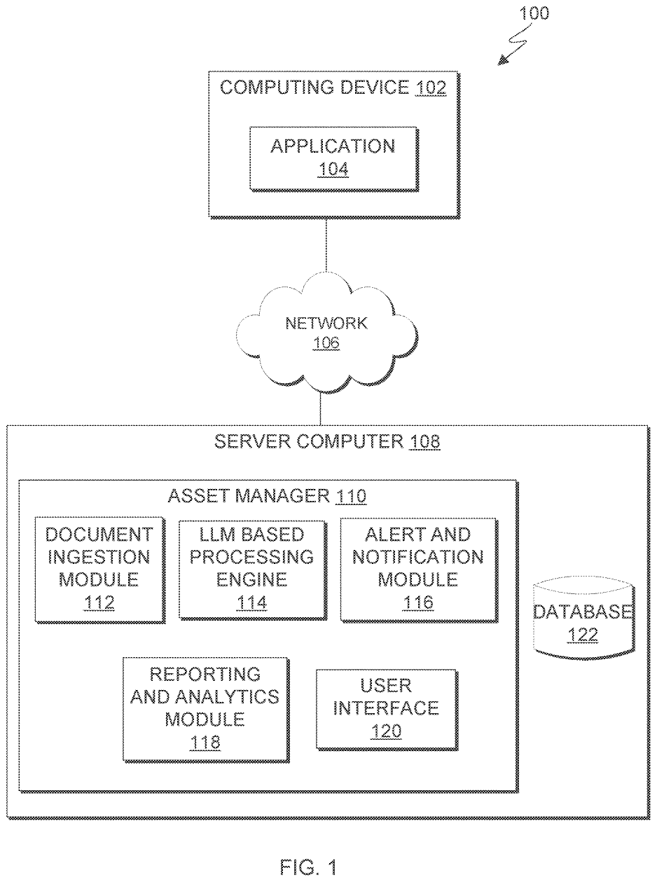

FIG. 1 is a functional block diagram illustrating an example computing environment, generally designated computing environment 100, in accordance with various embodiments of the systems and methods disclosed herein. FIG. 1 provides only an illustration of one implementation and does not imply any limitations with regard to the environments in which different embodiments may be implemented. Many modifications to the depicted environment may be made by those skilled in the art without departing from the scope of the various aspects of systems and methods disclosed herein, as recited by the claims.

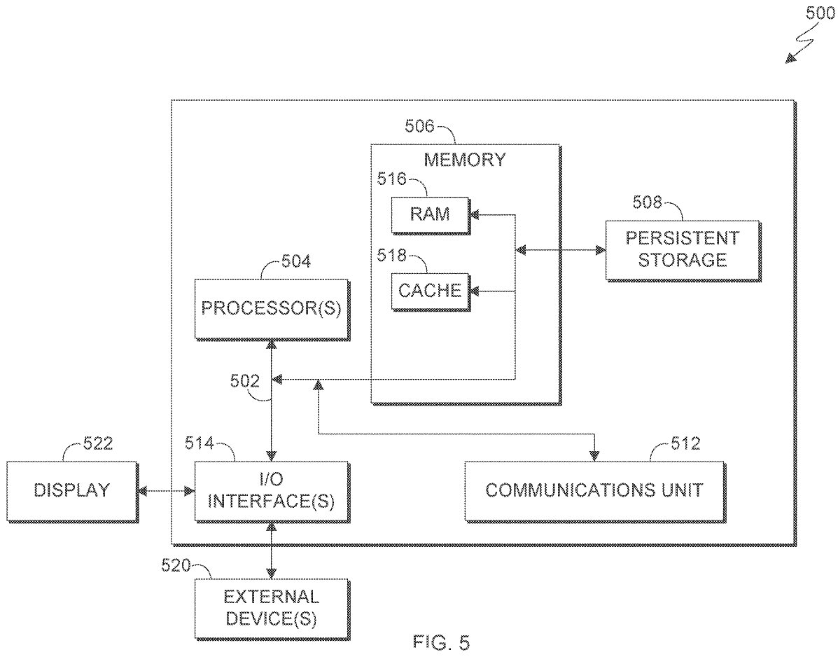

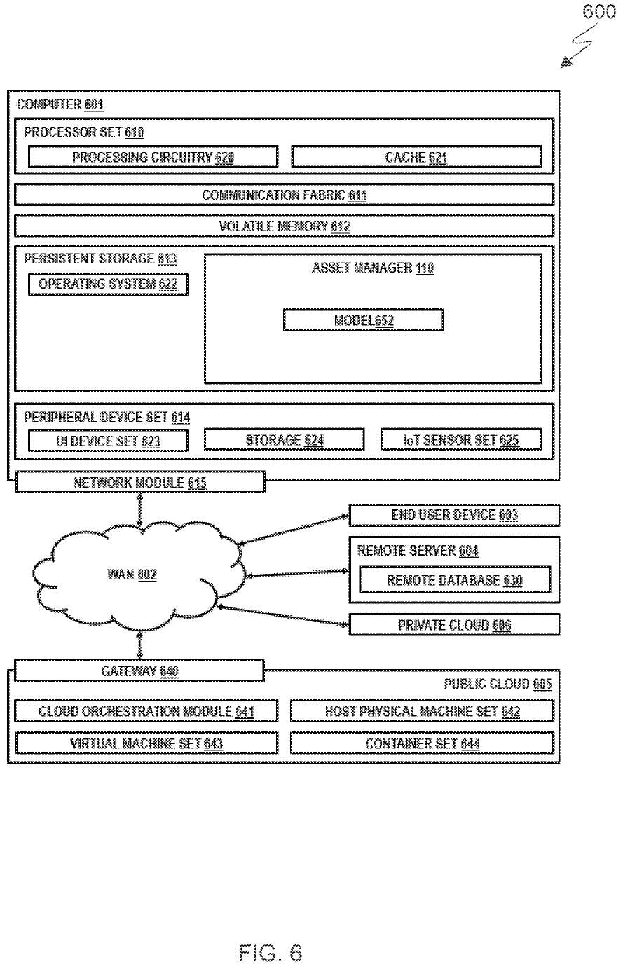

Computing environment 100 includes computing device 102 and server computer 108, all interconnected over network 106. Computing device 102 and server computer 108 can be a standalone computer device, a management server, a webserver, a mobile computing device, or any other electronic device or computing system capable of receiving, sending, and processing data. In other embodiments, computing device 102 and server computer 108 can represent a server computing system utilizing multiple computers as a server system, such as in a cloud computing environment, as depicted and described in further detail with respect to FIG. 6. In another embodiment, computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, computing device 102 and server computer 108 each represent a computing system utilizing clustered computers and components (e.g., database server computers, application server computers, etc.) that act as a single pool of seamless resources when accessed within computing environment 100. In some embodiments, computing device 102 and server computer 108 are a single device. Computing device 102 and server computer 108 may include internal and external hardware components capable of executing machine-readable program instructions, as depicted and described in further detail with respect to FIG. 5.

Computing device 102 is a digital device associated on or more entities utilizing an asset management system and users thereof. Computing device 102 includes application 104. Application 104 communicates with server computer 108 to access asset manager 110 (e.g., using TCP/IP) and database 122. Application 104 can further communicate with asset manager 110 to monitor a plurality of assets for compliance with asset related documentation, detect a change to one or more assets of the plurality of assets that deviate from parameters associated with the asset related documentation, in response to detecting a change to one or more assets of the plurality of assets that deviate from parameters associated with the asset related documentation, determine options for respective assets of the plurality of assets based on the detected change, and cause at least one asset of the plurality of assets to change its operational behavior or perform physical maintenance on the at least one asset of the plurality of assets based on the detected change and an analysis of the asset related documentation, as discussed in greater detail below. In general, application 104 can be implemented using a browser and web portal or any program that can interface with or otherwise access asset manager 110.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among computing device 102 and server computer 108, and other computing devices (not shown) within computing environment 100.

Server computer 108 is a digital device that hosts asset manager 110 and database 122. In this embodiment, asset manager 110 and database 122 reside on server computer 108. In other embodiments, asset manager 110 and/or database 122 can be stored locally on computing device 102. Other embodiments include asset manager 110 and/or database 122 being local to or virtually part of server computer 108. In yet other embodiments, an instance of asset manager 110 and/or database 122 can be stored on computing device 102 and can communicate with another instance of asset manager 110 residing on server computer 108. In some embodiments, asset manager 110 can be a stand-alone program on a computing device. In certain aspects of the systems and methods disclosed herein, asset manager 110 and database 122 can be cloud based, utilizing multiple computing devices, made available as a software as a service (SaaS), as part of an infrastructure as a service (IaaS) system, as part of a platform as a service (PaaS), etc.

Asset manager 110 provides a unified, end-to-end solution to efficiently manage a plurality of assets. Asset manager 110 includes document ingestion module 112, LLM based processing engine 114, alert and notification module 116, reporting and analytics module 118, and user interface 120. As used herein, an “asset” may be a type of object that is managed by the asset manager over an operational lifecycle and that is associated with asset-related documentation. An asset may include (i) a physical item installed, used, or maintained in connection with a facility or commercial operation (e.g., equipment, a building system, or a building component), and (ii) in some embodiments, a logical or digital representation of the physical item (e.g., an asset record, digital twin, or control-system representation) that is uniquely identifiable and associated with attributes, documentation, and lifecycle events.

In this embodiment, asset manager 110 provides this solution leveraging document ingestion module 112 to ingest one or more asset related documentation from disparate sources. In this embodiment, asset related documentation may refer to one or more documents that provide detailed information about assets, including their acquisition, operation, maintenance, and disposal. These documents ensure proper management and utilization of assets throughout their lifecycle. Examples of asset related documentation include warranties, operating manuals, maintenance manuals, invoice and receipts, purchase orders, service records, asset registers, decommissioning records, etc. Document ingestion module 112 is configured to process one or more document types and formats such as pdf files, computer aided design (CAD) files, image files, word processing documents, spreadsheet files, email and text files, HTML and XML files, etc. into structured, machine-readable text. In general, document ingestion module 112 enables asset manager 110 to access and analyze critical asset-related documentation, including warranties, maintenance manuals, and purchase orders. In this embodiment, document ingestion module 112 can leverage Optical Character Recognition (OCR) algorithms to transform non-digital text from scanned documents and images into digital text that can be easily indexed and searched. This transformation facilitates the integration of diverse data sources.

In some embodiments, document ingestion module 112 is further configured to receive asset documentation via a mobile scanning workflow. A mobile application associated with asset manager 110 captures an image of a manufacturer equipment placard affixed directly to an asset. Document ingestion module 112 applies prompt-engineered OCR processing to the captured image to extract key identification information, including manufacturer name, model number, and manufacture date. Asset manager 110 then initiates an automated web search using the extracted identification information to locate and download the corresponding manufacturer-specific operations and maintenance (O&M) documentation from supplier and manufacturer websites, which is then ingested into database 122 for subsequent LLM processing. In some embodiments, asset manager 110 is further configured to generate and print a machine-readable QR code label encoding the extracted asset identification information for physical attachment to the asset.

LLM based processing engine 114 is configured to leverage Large Language Models (LLMs) to perform text analysis and extract contextual information from the ingested one or more asset related documentation. As used herein, contextual information refers to additional data in the asset related documentation that help interpret the information provided within the document. This information identifies parameters and/or conditions, circumstances, dependencies, and relationships associated with the functioning, operation, maintenance, or warranty of the asset. For example, in an operating manual for an asset, the main content might be the operational procedures. Contextual information could include the recommended environmental conditions (e.g., temperature and humidity) that ensure optimal machine performance. This additional data helps users understand under what circumstances the procedures should be applied to achieve the best results. Other examples of extracted contextual information include coverage limitations and conditions (e.g., warranty coverage, expiration dates, warranty requirements, etc.), frequency and timing of maintenance activities, training and/or operating procedures, vendor details and transaction history, delivery timelines, repair and maintenance history, asset location and responsible personnel, reasons for asset retirement and future plans for replacement.

In this embodiment, LLM based processing engine 114 may use pre-trained and fine-tuned LLMs, which are capable of understanding and processing natural language with high accuracy. The pre-trained LLMs are fine-tuned to specialize in asset-related domains, enabling them to recognize industry-specific terminology and patterns. In this embodiment, LLM based processing engine 114 uses named entity recognition to identify and categorize key information, such as warranty durations and maintenance schedules. Extracted data is then structured and stored in a database (e.g., database 122).

In some embodiments, LLM based processing engine 114 may be further configured to perform automated web searches to retrieve supplemental asset data not available within the ingested O&M documentation. In this embodiment, LLM based processing engine 114 uses prompt engineering to query external manufacturer and supplier websites, databases, and other publicly accessible web sources using the asset's model number and manufacturer name as search parameters. Retrieved supplemental data may include expected equipment service life (expressed in years), estimated replacement cost (expressed in currency), and additional manufacturer-specific maintenance requirements. The retrieved data is stored in database 122 and associated with the corresponding asset record.

In some embodiments, LLM based processing engine 114 is further configured to automatically assign each ingested asset to one or more industry-standard classification taxonomies using prompt-engineered AI mapping. In this embodiment, LLM based processing engine 114 analyzes the content of the ingested O&M documentation to determine the applicable CSI MasterFormat division and subdivision (e.g., Division 23 00 00—Heating, Ventilating, and Air Conditioning) and the corresponding UniFormat classification (e.g., D3020—Heat Generating Systems). The assigned classifications are stored in database 122 with the asset record and are used by asset manager 110 to enable automated task routing to appropriately skilled technicians, standardized reporting by asset category, and capital planning outputs organized by construction division.

In some embodiments, asset manager 110 may include a curated preventive maintenance (PM) task library stored in database 122. The curated PM task library may comprise a repository of verified, human-reviewed preventive maintenance tasks indexed by asset manufacturer and model number. When LLM-based processing engine 114 processes an O&M document for an asset whose manufacturer and model number match an existing entry in the curated PM task library, asset manager 110 retrieves the pre-verified PM tasks from the library rather than generating tasks de novo from the LLM, thereby producing deterministic, consistent maintenance task outputs that avoid probabilistic variation inherent in generative LLM outputs. Asset manager 110 may further configure the curated PM task library entries for reuse across multiple customers whose asset inventories contain matching manufacturer and model numbers, enabling population of PM schedules at scale without repeated LLM inference.

In some embodiments, asset manager 110 may include an asset documentation query module (“Asset Chat”) configured to receive natural language queries from users in real time and return contextualized responses derived from asset-specific operations and maintenance (O&M) documentation stored in database 122. In this embodiment, a user associated with a specific asset submits a natural language troubleshooting query (e.g., “This unit is leaking water—what could be wrong?”) via user interface 120. LLM based processing engine 114 applies retrieval-augmented generation (RAG) techniques to identify and extract relevant sections of the O&M documentation associated with the queried asset, and returns a structured troubleshooting response including probable causes, affected components, and recommended corrective steps with source page references.

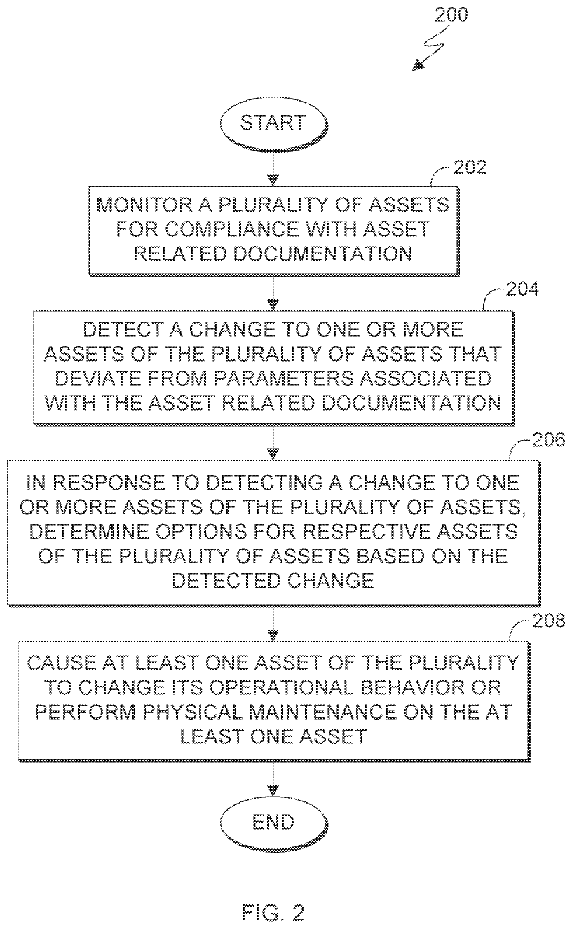

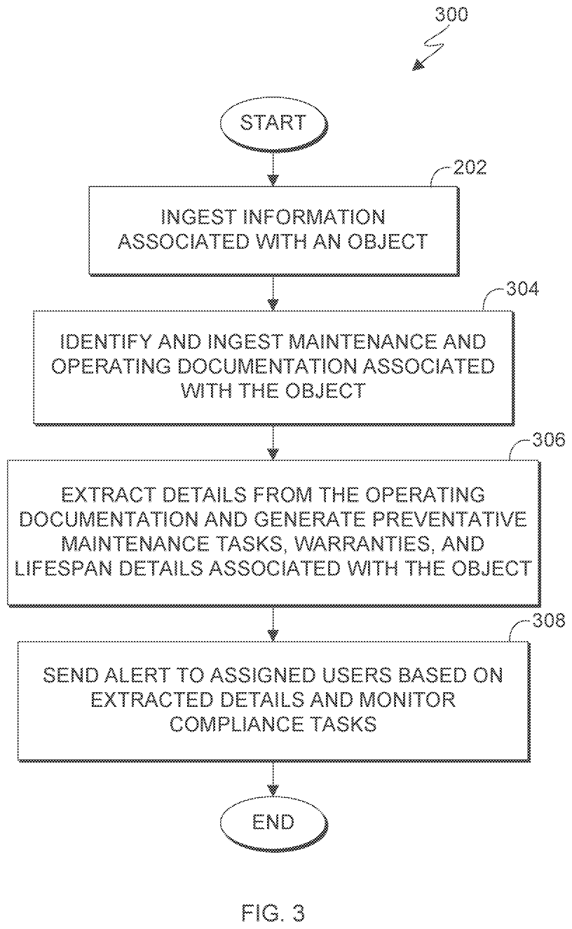

Alert and notification module 116 generates proactive alerts that serve as reminders for upcoming warranty expirations, overdue maintenance tasks, and training requirements. In this embodiment, alert and notification module 116 monitors data streams from LLM-based processing engine 114, which provides information on warranty terms, maintenance schedules, and training instructions. In this embodiment, alert and notification module 116 can utilize predefined thresholds and timelines to identify and detect changes to one or more assets that require alerts, such as an asset nearing its warranty expiration or a maintenance task that has not been performed on schedule and determine options for respective assets based on the detected change as described in greater detail with respect to FIG. 2. Alert and notification module 116 can then generate one or more alerts sent via email, SMS, or in-app notifications, ensuring that stakeholders receive timely and relevant information. Alert and notification module 116 also allows for customization of alert settings, enabling users to prioritize notifications based on their specific operational requirements.

In some embodiments, asset manager 110 may include an assignment module configured to consolidate preventive maintenance tasks, corrective maintenance service tickets, and warranty action items into a unified work assignment interface. In this embodiment, the assignment module automatically assigns tasks to individual technicians based on the asset's CSI MasterFormat classification and UniFormat designation, applying configurable priority rules and conditional permission constraints that restrict task visibility and execution rights to technicians with the appropriate trade qualifications (e.g., HVAC, Electrical, Plumbing). The assignment module further displays assigned tasks organized by technician in a board-style graphical interface accessible via user interface 120, and enables supervisors to reassign tasks, adjust priorities, and monitor completion status in real time.

Reporting and analytics module 118 leverages the comprehensive data collected and processed by asset manager 110 to provide detailed analyses of warranty utilization, compliance tracking, and asset performance trends. For example, asset manager 110 can generate one or more reports—asset tracking report, asset utilization report, compliance safety tracking, warranty utilization, lifecycle cost analysis, inventory management suggestions. In one embodiment, asset manager 110 can produce an asset tracking report, which details operational status and one or more action items that are pending (e.g., perform inspection, complete maintenance, and when warranty for that asset expires). In other embodiments, asset manager 110 can generate an asset utilization report and one or more graphics to show all assets, documents analyzes, value of assets, etc.

Additionally, asset manager 110 can generate compliance safety tracking reports to ensure that assets adhere to regulatory and safety standards. These alerts highlight upcoming inspections, certifications, and maintenance tasks required to maintain compliance. Asset manager 110 can also generate a lifecycle cost analysis reports, which provide a comprehensive evaluation of the total cost associated with an asset, including acquisition, operation, maintenance, and disposal expenses. These reports can assist in budgeting and forecasting, allowing organizations to assess the long-term value and cost-effectiveness of their assets. Finally, asset manager 110 can generate inventory management suggestions, offering guidance on optimal stock levels for spare parts and consumables based on historical usage and predictive analytics.

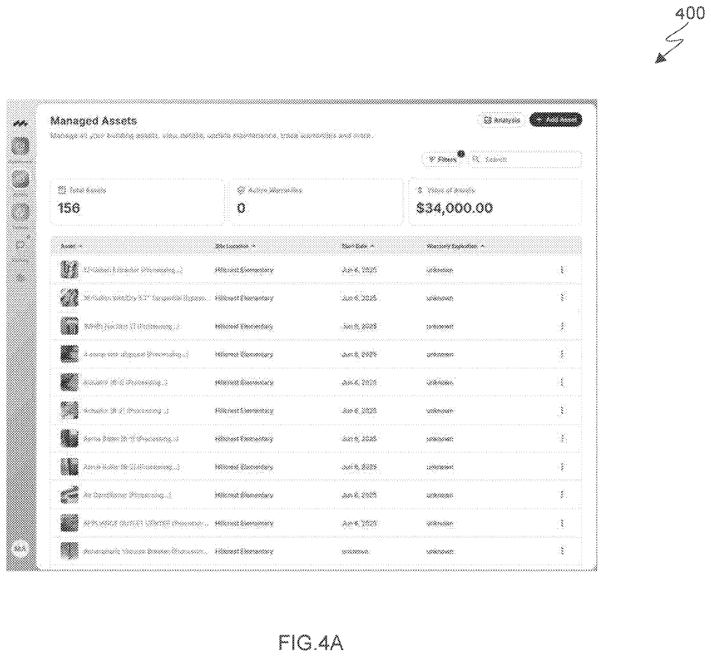

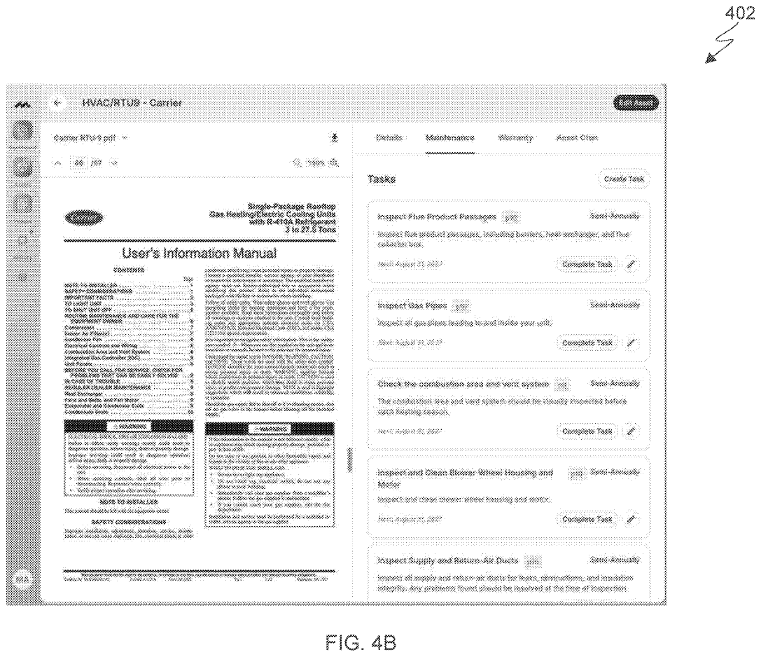

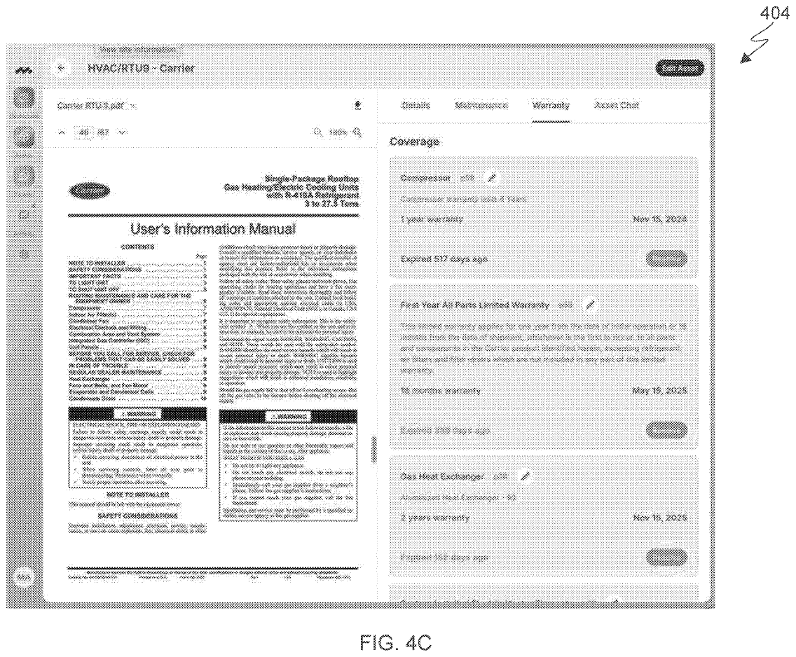

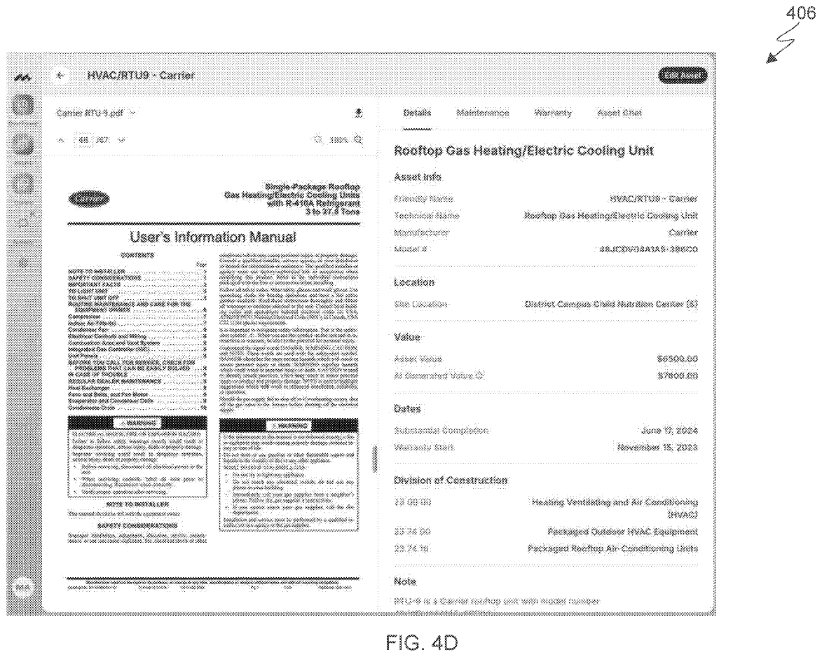

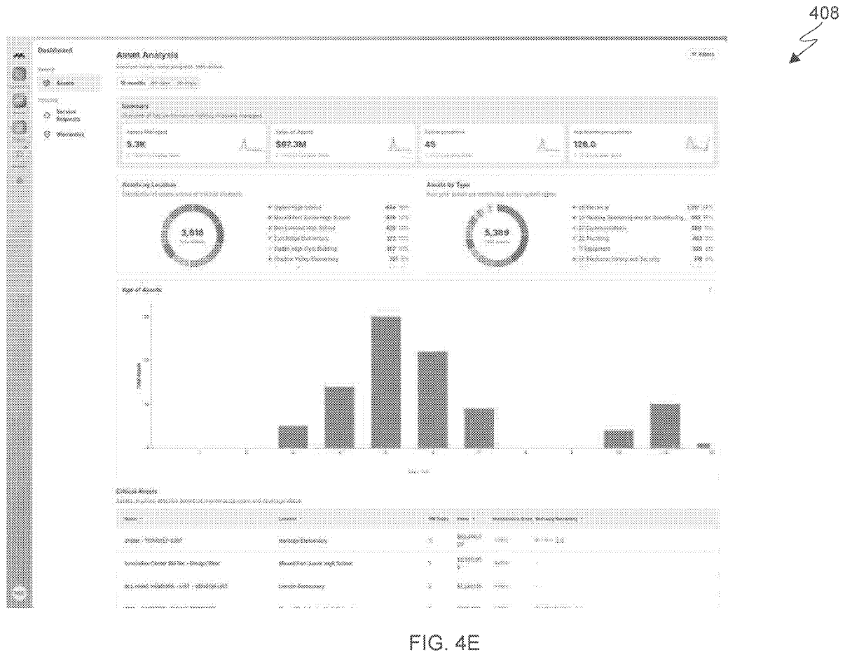

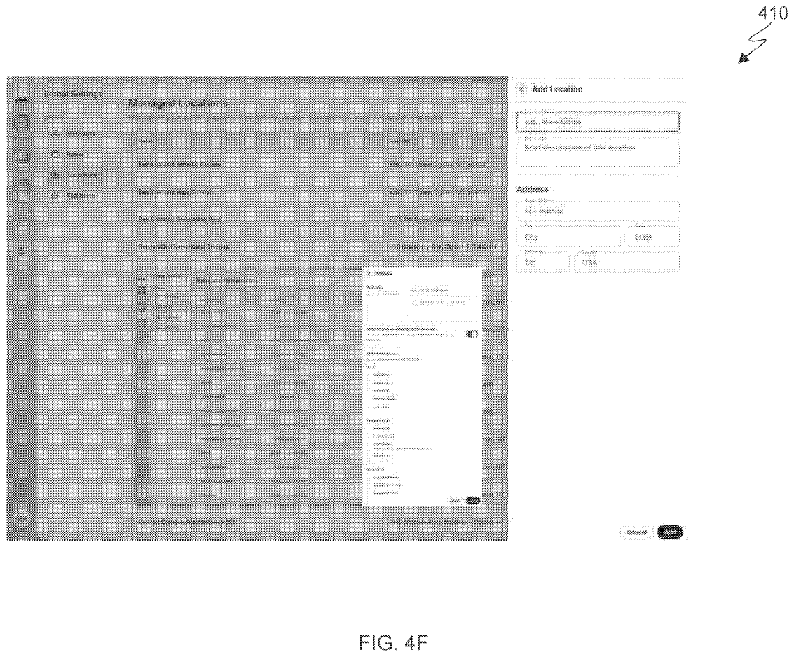

User interface 120 generates a graphic user interface display configured to display a representation of the plurality of assets, annotated asset related documents associated with respective assets of the plurality, one or more generated reports comprising graphical representations of warranty status for the plurality of assets, and one or more generated training material based on an analysis of the asset related documentation as discussed in greater detail with respect to FIGS. 4A-4F.

In general, database 122 can be implemented using any non-volatile storage media known in the art. For example, database 122 can be implemented with a tape library, optical library, one or more independent hard disk drives, or multiple hard disk drives in a redundant array of independent disk (RAID). In this embodiment database 122 is stored on server computer 108. In other embodiments, database 122 can be stored on other computing devices (not shown) or can be a combination of one or more other databases that has given permission access to asset manager 110.

Using one or more components of computing environment 100, asset manager 110 can monitor and manage an asset. For example, asset manager 110 can manage an HVAC asset, the HVAC system's documentation, and operational requirements. In response to receiving one or more asset related documentation via an upload of warranty and maintenance document by a facility manager, document ingestion module 112 ingests the files, utilizing Optical Character Recognition (OCR) to convert them into machine-readable text. Asset manager 110 can then feed this processed data into LLM-based processing engine 114, which applies natural language processing (NLP) techniques to extract contextual information such as the warranty expiration date, inclusions and exclusions, and detailed maintenance schedules. Leveraging the extracted information, alert and notification module 116 generates timely alerts for the facility manager, highlighting upcoming warranty expirations and required maintenance tasks. Additionally, reporting and analytics module 118 provides a comprehensive summary of training requirements specific to the HVAC system. This summary includes guidelines and instructions to ensure that staff members are adequately trained for proper usage and maintenance, reducing the risk of operational inefficiencies or system failures. Through the coordinated use of its modules, asset manager 110 optimizes performance and extends the lifespan of the HVAC system asset.

In another example, asset manager 110 can be used to addresses the problem of maintaining high standards in construction projects to ensure adherence to building standards and specifications outlined in 50 divisions of construction. Throughout various stages—design, architecture, contractor and subcontractor submittals, and the creation of operating and maintenance manuals—asset manager 110 can leverage document ingestion module 112 to gather and digitize relevant standards and specifications. LLM-based processing engine 114 then analyzes these documents and extracts compliance parameters such as warranty durations and material specifications. During the construction process, asset manager 110 continuously monitors submissions and proposals against the established standards. For instance, when a contractor suggests using roofing materials with a 20-year warranty and a 60 MM membrane thickness, which deviates from the required 30-year warranty and 80 MM thickness, asset manager 110 generates an alert that notifies one or more users of this discrepancy. Alert and notification module 116 then sends the generated alert to inform the one or more users, allowing for timely intervention to maintain the desired standards. In this manner, asset manager 110 can minimize risk and ensure compliance at each stage.

In another embodiment, asset manager 110 can be integrated into a selected Facility Management Suite. The Selected Facility Management Suit must include the following capabilities, organized by key functional areas. Each feature must be enabled by AI-driven tools to ensure automation, cost efficiency, and long-term asset lifecycle value.

### 1. AI-Powered Asset Management Repository

Centralized asset and equipment database for all district facilities spanning all building locations and asset types.
AI auto-identification and population of asset attributes using model numbers and manufacturer information for cost/replacement values, MasterFormat Divisions of Construction, operating and maintenance manuals, warranties, and other pertinent information.
AI-scanning of uploaded O&M (Operations & Maintenance) manuals to:
   Auto-classify assets into CSI MasterFormat Divisions.
   Extract and present simplified operational instructions for staff and end-users.
Ability to assign assets to specific facilities and rooms.
Version control and audit trail for any manual edits.
Ability to automatically add/edit assets details using AI.

### 2. Preventive Maintenance Management

AI extraction of OEM—and supplier-specified preventive maintenance tasks from O&M manuals or websites.
Automatic generation of:
   Maintenance schedules (weekly/monthly/seasonal/annual/etc).
   Interactive dashboards for task visibility and performance metrics.
   Alerts for upcoming, due, or overdue maintenance tasks.
Smart assignment of tasks by location and trade:
   e.g., HVAC, Electrical, Plumbing, Roofing, Flooring, Custodial, etc.
Integration with mobile apps or tablets for field technician use.
Capability to log and track completed maintenance tasks and attach notes/photos.

### 3. Corrective Maintenance & AI-Driven Ticketing System

Voice-to-text work order submission from any district employee using desktop or mobile device.
AI-driven categorization and triage of tickets based on:
   Type of issue.
   Urgency/severity.
   Location.
Auto-routing of tickets to appropriate internal teams or third-party vendors.
Real-time status tracking, notifications, and feedback loop with the submitter. Analytics for tracking MTTR (Mean Time to Repair), recurring issues, and technician productivity.

### 4. Warranty Management & Compliance Tracking

AI-driven ingestion and parsing of warranties (manufacturer, installer, general contractor).
Dashboard view of all active/inactive warranties with searchable filters.
Automated alerts for:
   Upcoming warranty expirations.
   Required PM tasks to keep warranties in force.
Linking of warranty contacts and claim submission instructions.
Historical record of claims submitted, approved, or denied.

### 5. Capital Planning & Lifecycle Forecasting

Auto-population of estimated useful life based on asset type, model, and manufacturer data.
Forecasted replacement timelines using inflation-adjusted cost modeling.
Visibility into long-term capital needs over a 5-, 10-, and 20-year horizon.
Capital planning reports by site and asset category..

### 6. AI-Driven New Construction Oversight (Standards Compliance Module)

Intake of district-approved building standards mapped to CSI MasterFormat.
Communication interface to share standards with architects and engineers.
AI monitoring of submitted specs and automatic alerting on deviations.
Workflow to manage deviation approvals or denials with record-keeping.
Bid intake portal for general contractors and subcontractors with AI validation of alignment to approved specs.
Standards, Specifications, Submittals, As-Built phase deviation tracking and alerting.
O&M manual and warranty submission portal post-construction with AI-based onboarding of new assets into the system.

### 7. Implementation & Legacy Documentation Integration

Manual and AI-assisted review and upload of all existing building documentation:
   As-built drawings
   O&M manuals
   Warranties
   Asset inventories
Identification and flagging of missing documentation.
Manual entry or approximation of initial asset values, install dates, and EOL (End of Life) dates when documentation is missing.
Training programs for district staff including:
   Admin configuration.
   Maintenance team onboarding.
   Teacher/staff use of ticketing system.
Timeline and milestone tracking for full implementation by facility.

### 8. System Architecture and Integration Requirements

Cloud-hosted or hybrid deployment model.
Secure multi-user access with granular permission controls.
API integration capabilities on request:
   District's existing CMMS (if applicable).
   ERP or finance systems.
   GIS and CAD systems.
Mobile application support for iOS and Android.
Data export capabilities for reports in Excel, CSV, and PDF formats.

### 9. Security, Compliance, and Support

Data encryption in transit and at rest.
Role-based access controls.
System uptime SLA of 99% or higher.
General business hour support from 9 am-5 pm MST.
Dedicated Customer Success Manager during implementation and onboarding

FIG. 2 is a flowchart depicting an example of operational steps for context based asset management, in accordance with various embodiments of the systems and methods disclosed herein.

In step 202, asset manager 110 monitor a plurality of assets for compliance with asset related documentation. In this embodiment, asset manager 110 can be integrated with one or more sensors positions detect a change to one or more assets of the plurality of assets that deviate from parameters associated with the asset related documentation. For example, certain aspects of the systems and methods disclosed herein can include one or more temperature, vibration, pressure, humidity, current, ultrasonic, and optical sensors to measure the condition, functioning, and operation of respective assets. In this manner, asset manager 110 can monitor temperature of equipment or components to detect overheating or abnormal temperature fluctuations, detect excessive vibrations or changes in vibration patterns that may indicate mechanical issues, identify leaks or blockages, detect moisture levels in environments where equipment is stored or operated to prevent corrosion or mold, detect overloads or energy inefficiencies, detect structural changes or measure distances to identify wear, and detect surface wear or alignment issues that can affect operation and warranty conditions. In other embodiments, asset manager 110 can receive readings and/or values for asset conditions according to predetermined time intervals or can receive manual input of asset conditions.

In step 204, asset manager 110 detects a change to one or more assets from the plurality of assets. In this embodiment, asset manager 110 can leverage one or more embedded sensors and IoT devices that measure critical metrics such as temperature, pressure, vibration, and energy consumption and compare the received measurements against baseline measurements for that asset. Asset manager 110 can then compare any detected changes with parameters associated with the asset related documentation (e.g., maintenance schedules outlined in warranty agreements to ensure compliance and optimize asset longevity). More specifically, asset manager 110 analyzes the asset-related documentation, including warranty terms and maintenance manuals, to determine whether the detected change corresponds with scheduled maintenance tasks, falls within warranty coverage, and/or whether the detected change reaches a threshold value that indicates action should be taken to replace or perform a maintenance task.

Asset manager 110 can also compare any detected changes to parameters associated with the asset related documentation to identity whether any of the detected changes deviate from parameters associated with the asset related documentation that indicate normal performance. For example, asset manager 110 can compare any detected changes to baseline operating values referenced in an operating manual for the asset to determine whether the detected changes deviate from other parameters specifying normal operating values and conditions. In another example, asset manager 110 can reference a threshold value for normal operating values of an asset found in the asset's related documentation and determine changes that reach or exceed the threshold value deviates from acceptable parameters defined by the asset's related documentation.

In step 206, in response to detecting a change to one or more assets of the plurality of assets that deviate from parameters associated with the asset related documentation, asset manager 110 can determine options for respective assets based on the detected change. An option, as used herein, refers to one or more actionable recommendations based on real-time monitoring and analysis of asset conditions and asset related documentation. Examples of options asset manager 110 can generate include a recommendation to perform a maintenance task for respective assets, a suggestion of a replacement part for the respective assets, or an option to submit a warranty claim for the respective assets based on the detected change and an analysis of the asset related documentation. In some instances, asset manager 110 can further include an alert for upcoming warranty expiration dates and parameter conditions to satisfy the warranty claim. In this manner, asset manager 110 can take proactive measures to ensure optimal performance, reduce downtime, prevent potential failures, and extend asset lifespan.

In step 208, asset manager 110 causes at least one asset of the plurality of assets to change its operational behavior or perform physical maintenance on the at least one asset. For example, in response to receiving real-time data inputs from various sensors and its analysis of asset related documentation, asset manager 110 can utilize its integrated control protocols to interface directly with the asset's control systems. This interface allows for seamless communication and command execution to adjust an asset's operational behavior in accordance with the prescribed settings. To facilitate this change, asset manager 110 can deploy one or more instructions tailored to the asset's specific requirements based on its analysis of asset related documentation. Examples of these instructions may include altering the asset's functional parameters, such as speed, temperature settings, or energy consumption levels to align with optimal performance standards. Additionally, asset manager 110 can initiate automated sequences for the asset's subsystems to recalibrate or reset certain functionalities to optimize efficiency and reduce wear and tear. By leveraging one or more machine learning algorithms, asset manager 110 continuously refines its operational directives based on historical data and predictive analytics. In this manner, asset manager 110 can ensure that each asset maintains optimal performance and extends its lifecycle through proactive behavior modifications.

Asset manager 110 can also perform physical maintenance on the at least one asset of the plurality of assets based on the detected change and an analysis of the asset related documentation. For example, in response to detecting a change to one or more assets of the plurality of assets that deviate from parameters associated with the asset related documentation asset manager 110 conducts a comprehensive analysis using asset-related documentation, including maintenance manuals, warranty information, and historical service records. This analysis enables asset manager 110 to identify potential issues and determine the appropriate maintenance actions required to restore optimal asset functionality. As used herein, “performing physical maintenance” on an asset includes causing, coordinating, initiating, scheduling, or otherwise effectuating one or more physical maintenance actions with respect to the asset based on analysis performed by the asset manager. In various embodiments, the physical maintenance actions are carried out by (i) human technicians, (ii) automated or robotic maintenance equipment, and/or (iii) third-party service providers, while the asset manager performs the corresponding computing operations to determine the maintenance action, generate one or more maintenance tasks, and trigger execution of the maintenance action. For example, the asset manager may generate and transmit a maintenance work order, dispatch instructions, or step-by-step maintenance guidance to a technician device (e.g., a mobile application), including identified parts/tools, safety prerequisites, and documentation citations. In other embodiments, for assets equipped with controllable subsystems or automated maintenance equipment, the asset manager may issue control commands (e.g., via an equipment gateway or control protocol) that cause the automated maintenance equipment to perform a specified maintenance sequence (e.g., calibration, cleaning, component replacement), thereby effectuating the physical maintenance.

Once the maintenance requirements are identified, asset manager 110 coordinates with automated maintenance systems or human technicians to execute the necessary physical interventions. In this embodiment, asset manager 110 generates maintenance schedules and task lists, specifying the parts and tools needed for repairs or servicing. Additionally, asset manager 110 can send one or more alerts and instructions to on-site personnel to guide them through the maintenance process based on the asset related documentation. For assets equipped with robotic or automated maintenance units, asset manager 110 can directly control these units to perform tasks such as component replacement, lubrication, calibration, or cleaning, ensuring that maintenance is conducted efficiently and in accordance with established guidelines.

By performing the operational steps of flowchart 200, asset manager 110 can leverage real-time data and documentation analysis to manage a plurality of assets to ensure timely maintenance execution, reduce downtime, and increase asset lifespan.

FIG. 4A is an example graphical user interface configured to display a managed-assets dashboard, in accordance with various embodiments of the systems and methods disclosed herein.

Example managed-assets dashboard 400, rendered by user interface 120 on computing device 102 (e.g., via application 104), may provide an asset and document management tracking interface that enables a user to manage an asset inventory. In this embodiment, asset manager 110 may populate dashboard 400 using asset records stored in database 122 and update the displayed content as document ingestion module 112. LLM-based processing engine 114 may then ingest and analyze newly added asset-related documentation.

Dashboard 400 presents portfolio-level summary metrics that characterize the managed asset portfolio, such as total assets, active warranties, aggregate value of assets, and one or more service request or ticket indicators. Dashboard 400 may also include interactive search and filter controls that allow the user to locate and segment assets by attributes such as site/location, asset name/type, processing status, start date, and warranty expiration.

Dashboard 400 may further include an asset list region that displays individual asset entries and associated fields (e.g., asset name, site/location, start date, and warranty expiration). When asset manager 110 continues to process an asset's documentation, asset manager 110 marks the corresponding asset entry with a processing indicator (e.g., “Processing . . . ”) and updates warranty expiration and other extracted fields after LLM-based processing engine 114 completes extraction and standardization. Dashboard 400 thereby provides a centralized view that allows a user to track asset onboarding progress, review high-level warranty status, and navigate to asset-specific detail views for maintenance, warranty, and related documentation management.

FIG. 4B shows an example graphical user interface configured to display an asset and task tracking interface, in accordance with various embodiments of the systems and methods disclosed herein.

In particular, FIG. 4B illustrates an example asset detail interface 402 rendered by user interface 120 on computing device 102 (e.g., via application 104. In this embodiment, asset manager 110 configures interface 402 to present an asset-specific workspace for a selected asset and to provide tabbed navigation that includes Details, Maintenance, Warranty, and Asset Chat.

In the Details tab, asset manager 110 presents core asset record information maintained in database 122, including asset identification and classification fields (e.g., friendly name, technical name, manufacturer, model number, location, value, relevant dates, and division-of-construction classification), and asset manager 110 provides controls for editing one or more of the fields and for accessing associated asset documentation.

In the Maintenance tab (shown in FIG. 4B), asset manager 110 displays a preventive maintenance task list generated from extracted and standardized information produced by LLM-based processing engine 114 based on ingested operating and maintenance documentation stored in database 122. Asset manager 110 displays each task with associated attributes such as a task name, a source reference to the underlying documentation (e.g., page identifiers), a frequency designation (e.g., semi-annually), and a next scheduled date, and asset manager 110 provides task action controls (e.g., create task and complete task) that allow a user to manage execution and scheduling of the tasks. Interface 402 also includes a document viewing region that renders the ingested manufacturer documentation associated with the selected asset and allows the user to verify extracted task requirements against source content.

In the Warranty tab, asset manager 110 presents warranty coverage information associated with the selected asset, including one or more warranty coverages for different components, applicable warranty periods, warranty start dates, expiration dates, and status indicators (e.g., active or expired). Asset manager 110 links warranty fields to corresponding source sections in the ingested documentation and uses alert and notification module 116 to drive warranty-related alerts (e.g., upcoming expirations and warranty-preservation conditions) and reporting and analytics module 118 to track warranty utilization and compliance.

In the Asset Chat tab, asset manager 110 receives natural-language queries from a user about the selected asset (e.g., troubleshooting questions, operating instructions, maintenance procedures, and warranty questions) and generates contextualized responses derived from asset-specific documentation stored in database 122. In this embodiment, asset manager 110 uses LLM-based processing engine 114 to retrieve relevant passages from the documentation and to return structured guidance that includes recommended steps and source references to the underlying documentation..

FIG. 4C is example diagram showing a graphical user interface configured to display a warranty tracking interface, in accordance with various embodiments of the systems and methods disclosed herein.

Warranty tracking interface 404 is rendered by user interface 120 on computing device 102 (e.g., via application 104). In this embodiment, asset manager 110 configures interface 404 to present warranty information for a selected asset and to provide tabbed navigation that includes Details, Maintenance, Warranty (selected), and Asset Chat.

In the Warranty tab, asset manager 110 displays a warranty coverage region that enumerates one or more warranty coverages associated with the selected asset, including component-level warranties (e.g., compressor coverage, heat exchanger coverage, and all-parts coverage). Asset manager 110 populates the warranty fields using warranty terms extracted and standardized by LLM-based processing engine 114 from ingested asset-related documentation stored in database 122. In this embodiment, asset manager 110 displays, for each coverage entry, one or more of: a coverage name for an object (i.e., selected asset) being covered, a source reference (e.g., a page identifier within the ingested manual), a warranty duration, an applicable warranty start date, an expiration date, and a status indicator that identifies whether the coverage is active or expired.

Interface 404 may further include one or more user action controls (e.g., a Resolve control) that allow a user to acknowledge, remediate, or otherwise disposition a warranty-related item (e.g., an expired warranty, an upcoming expiration, or a coverage discrepancy). In response to user interaction with the action controls, asset manager 110 may record the resulting status in database 122 and communicates warranty state changes to alert and notification module 116 and reporting and analytics module 118 to support warranty expiration alerts, warranty utilization reporting, and compliance tracking.

Interface 404 may also include a document viewing region that renders the ingested manufacturer documentation associated with the selected asset. Asset manager 110 may display the warranty coverage entries alongside the document viewing region to allow a user to validate extracted warranty terms against the underlying source text and to review related warranty conditions, exclusions, and claim instructions while managing the asset's warranty profile.

FIG. 4D is example diagram showing a graphical user interface configured to display a details interface, in accordance with various embodiments of the systems and methods disclosed herein.

In particular, FIG. 4D illustrates an example asset details interface 406 rendered by user interface 120 on computing device 102 (e.g., via application 104). In this embodiment, asset manager 110 may configure interface 406 to present an asset-specific workspace for a selected asset and to provide tabbed navigation that includes Details, Maintenance, Warranty, and Asset Chat, where the Details tab is selected.

In the Details tab, asset manager 110 displays an Asset Info region that presents core asset record fields stored in database 122, including a friendly name, a technical name, a manufacturer identifier, a model number, and a location designation (e.g., site and sub-location). Asset manager 110 further provides edit controls that allow a user to modify one or more fields and store the modifications in database 122 as part of the asset record.

Interface 406 further includes a Value region in which asset manager 110 displays an asset value and, in some embodiments, an AI-generated value. Asset manager 110 generates the AI-generated value using extracted information from asset-related documentation and/or supplemental web-sourced information obtained and processed by LLM-based processing engine 114, and asset manager 110 stores the generated value in database 122 for budgeting, forecasting, and reporting.

Interface 406 may also include a Dates region that lists lifecycle and warranty-related dates associated with the selected asset (e.g., substantial completion and warranty start). Asset manager 110 uses these dates to drive scheduling logic for preventive maintenance tasks and to configure alert criteria for warranty expirations via alert and notification module 116.

Interface 406 may further include a Division of Construction region that displays one or more industry-standard classifications associated with the selected asset). Asset manager 110 assigns the classifications using LLM-based processing engine 114 and stores the classifications in database 122 to support standardized reporting, analytics, and task routing to appropriately qualified personnel.

Interface 406 may also include a document region that lists and renders ingested asset-related documentation associated with the selected asset (e.g., a manufacturer User's Information manual). Asset manager 110 presents the documentation within interface 406 to allow a user to review source content that supports the displayed asset fields and to navigate to related workflows in the Maintenance, Warranty, and Asset Chat tabs.

FIG. 4E is example diagram showing a graphical user interface configured to display a reporting and analytics interface, in accordance with various embodiments of the systems and methods disclosed herein.

In particular, FIG. 4E illustrates an example reporting and analytics interface 408 rendered by user interface 120 on computing device 102 (e.g., via application 104). In this embodiment, asset manager 110 may configure interface 408 to present portfolio-level analytics generated by reporting and analytics module 118 based on asset records, warranty records, maintenance task records, and service request records stored in database 122.

In interface 408, asset manager 110 may present selectable time windows and filtering controls (e.g., 12 months, 90 days, 30 days) that allow a user to change the analysis period and segment the displayed metrics. Asset manager 110 updates the displayed metrics and visualizations in response to user selections to reflect the corresponding subset of underlying data.

Interface 408 may include summary regions that display key performance indicators for the managed asset portfolio, including asset counts, counts of tickets or service requests, aggregate asset value, warranty-related counts, and location-level indicators. Interface 408 may also include distribution visualizations that depict how assets are allocated across locations and across asset categories by type, thereby enabling the user to identify concentration of assets by site and trade.

Interface 408 may further include age and condition visualizations, including an age-of-assets chart and a “critical assets” region. In the critical assets region, asset manager 110 ranks and lists assets requiring attention based on one or more scoring outputs produced by reporting and analytics module 118, such as maintenance score, warranty remaining, and task completion status, and asset manager 110 presents associated context (e.g., location, number of PM tasks, and value) to support prioritization and corrective action.

In this manner, interface 408 may provide a consolidated analytics dashboard that allows a user to monitor trends, identify high-risk assets, and take action based on portfolio-level reporting generated from standardized data extracted and maintained by asset manager 110.

FIG. 4F is example diagram showing a graphical user interface configured to display administrative settings, in accordance with various embodiments of the systems and methods disclosed herein.

In particular, FIG. 4F illustrates an example administrative settings interface 410 rendered by user interface 120 on computing device 102 (e.g., via application 104). In this embodiment, asset manager 110 configures interface 410 to allow authorized users to manage organizational configuration data that controls how asset manager 110 organizes assets, assigns work, and enforces access permissions.

In interface 410, asset manager 110 may display a Managed Locations region that lists a plurality of managed locations (e.g., buildings, campuses, and facilities), including location identifiers such as a location name and address. Asset manager 110 associates each asset record stored in database 122 with a managed location to support location-based asset filtering, reporting, and task assignment.

Interface 410 further presents an Add Location workflow (e.g., via a modal window) that allows a user to create or edit a managed location by entering location attributes such as location name, description, and address fields. In response to user input, asset manager 110 stores the location record in database 122 and updates the managed locations list to include the new or updated location.

Interface 410 also provides a Roles and Permissions region that overlays over the Managed Locations region that allows a user to define and manage role-based access control settings. In this embodiment, asset manager 110 displays an Add Role workflow overlay that enables the user to specify role identifiers (e.g., role name and description), configure whether the role participates in ticket assignment, and select permission settings for functional areas including, by way of example, assets, documents, alerts, and ticketing features.

Asset manager 110 applies the role definitions and permission settings to control user access to features presented in user interface 120 and to constrain operational actions within asset manager 110, including restricting visibility and execution rights for assigned tasks, alerts, and administrative functions to users associated with authorized roles.

FIG. 5 depicts a block diagram of components of computing systems within computing environment 100 of FIG. 1, in accordance with an aspect of the systems and methods of the present disclosure. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment. However, it should be appreciated that any particular program nomenclature herein is used merely for convenience, and thus aspects of the systems and methods disclosed herein should not be limited to use solely in any specific application identified and/or implied by such nomenclature.

Computer system 500 includes communications fabric 502, which provides communications between cache 518, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM) 516. In general, memory 506 can include any suitable volatile or non-volatile computer readable storage media. Cache 518 is a fast memory that enhances the performance of computer processor(s) 504 by holding recently accessed data, and data near accessed data, from memory 506.

Asset manager 110 (not shown) may be stored in persistent storage 508 and in memory 506 for execution by one or more of the respective computer processors 504 via cache 518. In an embodiment, persistent storage 508 includes a magnetic hard disk drive. Alternatively, or in addition to a magnetic hard disk drive, persistent storage 508 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Asset manager 110 may be downloaded to persistent storage 508 through communications unit 510.

I/O interface(s) 512 allows for input and output of data with other devices that may be connected to computing device 102 and server computer 108. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice aspects of the present disclosure can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

Aspects of the various systems and methods may be a system, a method, and/or a computer program product (CPP). Various aspects of the disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Aspects of the systems and methods of the present disclosure are described herein with reference to flowchart illustrations and/or block diagrams of methods, apparatus (systems), and computer program products according to aspects of the various systems and methods disclosed herein. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the systems and methods of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects of the systems and methods of the present disclosure have been presented for purposes of illustration but are not intended to be exhaustive or limited to the embodiments disclosed. Many modifications and variations will be apparent to those of ordinary skill in the art without departing from the scope and spirit of aspects of the present disclosure. The terminology used herein was chosen to best explain the principles of the embodiment, the practical application or technical improvement over technologies found in the marketplace, or to enable others of ordinary skill in the art to understand the embodiments disclosed herein.

FIG. 6 depicts an alternate computing environment 600 illustrating components of computer 601 in accordance with an alternate embodiment. It should be appreciated that FIG. 6 provides only an illustration of one implementation and does not imply any limitations with regard to the environments in which different embodiments may be implemented. Many modifications to the depicted environment may be made.

Computing environment 600 contains an example of an environment for the execution of at least some of the computer code involved in performing the inventive methods, such as providing a unified solution that monitors a plurality of assets for compliance with asset related documentation, detects a change to one or more assets of the plurality of assets that deviate from parameters associated with the asset related documentation, in response to detecting a change to one or more assets of the plurality of assets that deviate from parameters associated with the asset related documentation, determines options for respective assets of the plurality of assets based on the detected change, and causes at least one asset of the plurality of assets to change its operational behavior or perform physical maintenance on the at least one asset of the plurality of assets based on the detected change and an analysis of the asset related documentation.

In addition to asset manager 110, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and asset manager 110, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip”. In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in member key program 610 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in asset manager 110 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Asset manager 110 is a program, a subprogram of a larger program, an application, a plurality of applications, or mobile application software, which functions to provide a unified solution that can provide a unified solution to provide context based management of a plurality of assets. In various embodiments, asset manager 110 may implement the following steps: monitoring, by one or more processors, a plurality of assets for compliance with asset related documentation; detecting, by the one or more processors, a change to one or more assets of the plurality of assets that deviate from parameters associated with the asset related documentation; in response to detecting a change to one or more assets of the plurality of assets that deviate from parameters associated with the asset related documentation, determining, by the one or more processors, options for respective assets of the plurality of assets based on the detected change; and causing, by the one or more processors, at least one asset of the plurality of assets to change its operational behavior or performing, by the one or more processors, physical maintenance on the at least one asset of the plurality of assets based on the detected change and an analysis of the asset related documentation. In another embodiment, the functionality of asset manager 110, or any combination programs thereof, may be integrated into a single software program. In some embodiments, asset manager 110 may be located on separate computing devices (not depicted) but can still communicate over WAN 602. In various embodiments, client versions of asset manager 110 resides on any other computing device (not depicted) within computing environment 600. In the depicted embodiment, asset manager 110 includes model 652 and can leverage model 652 to monitor a plurality of assets for compliance with asset related documentation and detecting a change to the one or more assets of the plurality that deviate from parameters associated with the asset related documentation.

Model 652 is representative of a model utilizing deep learning techniques to train, calculate weights, ingest inputs, and output a plurality of solution vectors. In an embodiment, model 652 is comprised of any combination of deep learning model, technique, and algorithm (e.g., decision trees, Naive Bayes classification, support vector machines for classification problems, random forest for classification and regression, linear regression, least squares regression, logistic regression). In an embodiment, model 652 utilizes transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. In the depicted embodiment, model 652 is a recurrent neural network (RNN) trained utilizing supervised training methods.

Aspects of the present disclosure may contain various accessible data sources, such as database 654, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Asset manager 110 may provide informed consent, with notice of the collection of personal data, allowing the user to opt in or opt out of processing personal data. Consent can take several forms: opt-in consent imposes on the user to take an affirmative action before the personal data is processed, alternatively, opt-out consent imposes on the user to take an affirmative action to prevent the processing of personal data before the data is processed. Asset manager 110 enables the authorized and secure processing of user information, such as tracking information, as well as personal data, such as personally identifying information or sensitive personal information. Asset manager 110 may provide information regarding the personal data and the nature (e.g., type, scope, purpose, duration, etc.) of the processing. Asset manager 110 may provide the user with copies of stored personal data. Asset manager 110 may allow the correction or completion of incorrect or incomplete personal data. Asset manager 110 may allow the immediate deletion of personal data.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

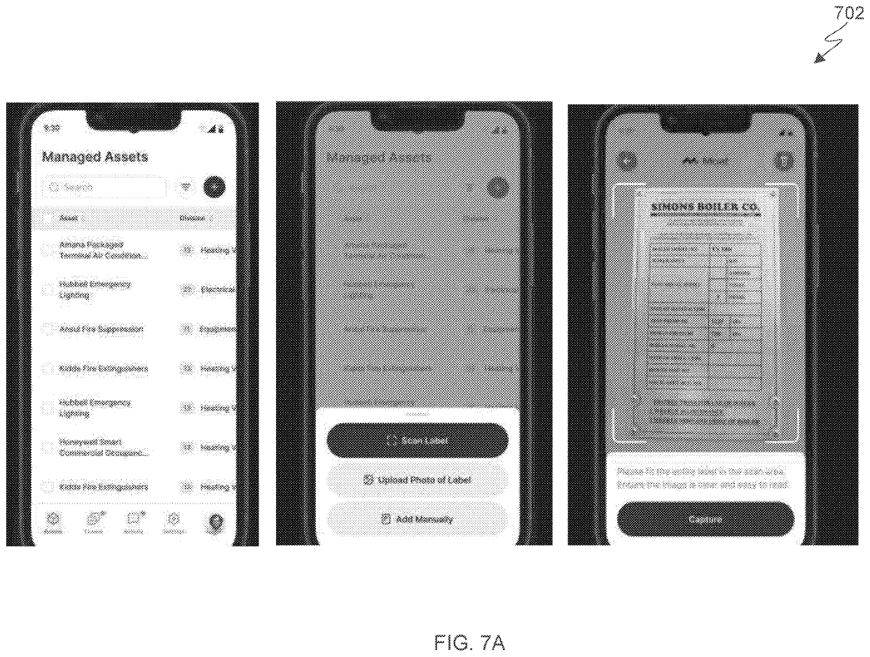

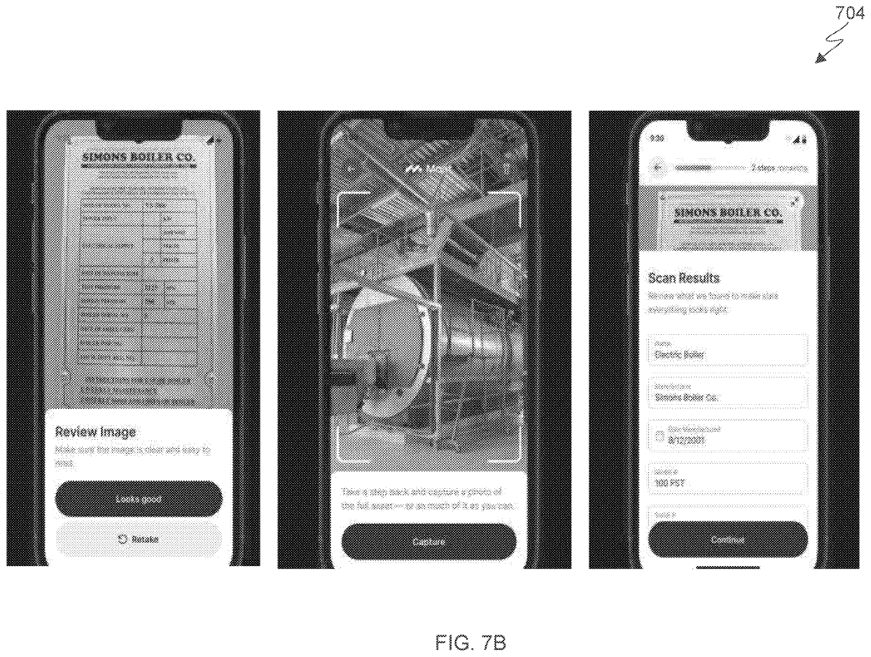

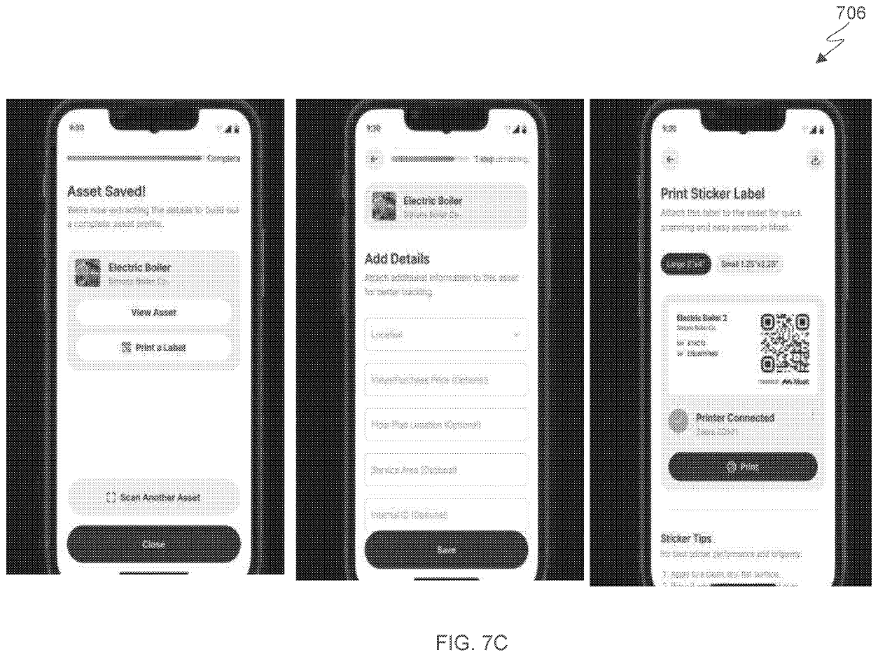

FIGS. 7A, 7B, and 7C represent an example diagram showing a graphical user interface configured to display a mobile scanning workflow for capturing manufacturer equipment placard information, generating asset identification data via OCR, and printing a machine-readable QR code label, in accordance with various embodiments of the systems and methods disclosed herein.

In particular, FIG. 7A illustrates an example mobile asset scanning workflow rendered by user interface 120 on a mobile computing device 102 as shown by example user interfaces 702. In the left image of FIG. 7A, asset manager 110 presents a managed assets view that allows a user to initiate capture of an asset placard (e.g., via a scan control) while also viewing previously onboarded assets and associated classification data (e.g., division of construction). In the middle image of FIG. 7A, asset manager 110 activates a camera capture interface and guides the user to capture an image of the manufacturer placard affixed to the asset such that the manufacturer name, model number, and other identifiers appear within a scan region. In the right image of FIG. 7A, asset manager 110 presents an image review interface that prompts the user to confirm image clarity and completeness before the system proceeds with extraction of placard data.

FIG. 7B continues the example mobile workflow of FIG. 7A after the user confirms the captured image. FIG. 7B shows example user interfaces 704 which depicts a next set of user interface interactions. In the left image of FIG. 7B, asset manager 110 stores the captured placard image, initiates OCR processing via document ingestion module 112, and begins extraction of key identification fields (e.g., manufacturer name, model number, manufacture date, and serial number). In the middle image of FIG. 7B, asset manager 110 prompts the user to provide additional capture inputs that improve onboarding accuracy, including capturing a full-asset photo and confirming a serial number when available, and asset manager 110 associates those inputs with the asset record in database 122. In the right image of FIG. 7B, asset manager 110 confirms that the system saved the asset record and indicates that the system continues processing in the background, including initiating an automated web search using the extracted manufacturer and model number to locate corresponding manufacturer operating and maintenance documentation for ingestion and downstream LLM processing.

FIG. 7C illustrates example user interfaces 706 that finalize onboarding and enable physical labeling of the asset. In the left image of FIG. 7C, asset manager 110 presents a “scan results” review interface that displays extracted identification fields (e.g., asset name, manufacturer, date manufactured, and model number) and allows the user to correct or confirm the fields prior to finalizing the asset profile. In the middle image of FIG. 7C, asset manager 110 provides label-generation controls that allow the user to print a machine-readable label (e.g., QR code label) encoding the asset identification information, and asset manager 110 provides options to add supplemental asset attributes (e.g., value/purchase price and location metadata) to improve tracking. In the right image of FIG. 7C, asset manager 110 confirms connectivity with a label printer and executes a print operation to generate the physical label for attachment to the asset, thereby enabling subsequent retrieval of the asset profile, maintenance tasks, warranty details, alerts, and troubleshooting guidance through future scans.

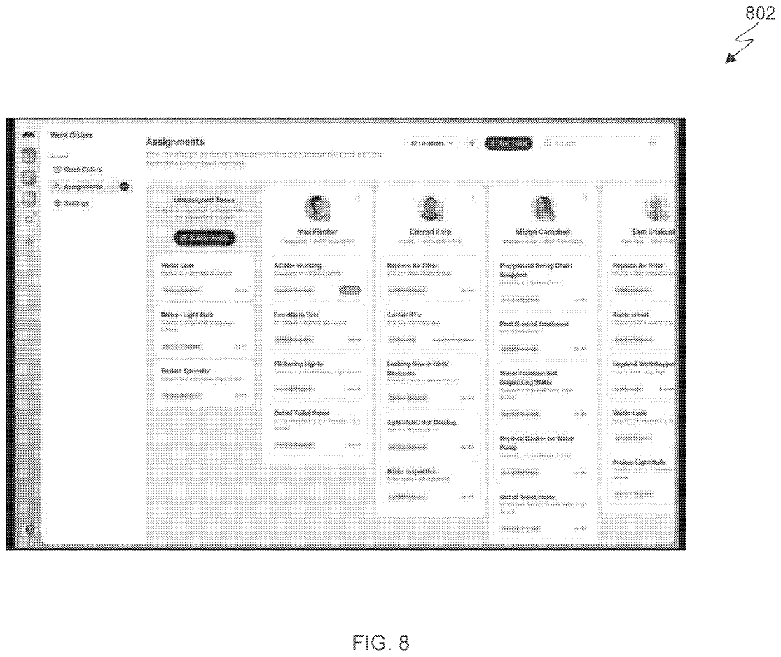

FIG. 8 is an example screenshot showing a graphical user interface configured to display an assignment board, in accordance with various embodiments of the systems and methods disclosed herein.

In particular, FIG. 8 shows graphical user interface 802 configured to display an assignment board that consolidates preventive maintenance tasks, service tickets, and warranty action items with automated technician assignment based on asset classification and configurable permission rules, in accordance with various embodiments of the systems and methods disclosed herein. More specifically, FIG. 8 illustrates an example work order and assignment interface rendered by user interface 120 on computing device 102 (e.g., via application 104), in accordance with various embodiments of the systems and methods disclosed herein. In this embodiment, asset manager 110 configures FIG. 8 to present a unified work allocation view that consolidates preventive maintenance tasks, corrective maintenance service requests, and warranty expiration action items for assignment to one or more users.

In FIG. 8, asset manager 110 displays a board-style assignment region that includes an unassigned lane and a plurality of assignee lanes corresponding to individual users and/or role-based trade groups (e.g., HVAC, electrical, custodial, maintenance). Asset manager 110 associates each task card with standardized industry classification data (e.g., HVAC, electrical, plumbing) derived from LLM-based processing engine 114 and stored in database 122, and asset manager 110 uses the standardized classification data to support routing and filtering of tasks by trade and skill requirements.

Asset manager 110 generates and displays task cards that identify an underlying work type (e.g., “Maintenance,” “Service Request,” or “Warranty”), an associated asset or equipment reference, and a location reference and associated tasks/requests (e.g., AC Not working, Fire alarm Test, Flickering Lights, Out of Toiler Paper). For warranty-related items, asset manager 110 displays an expiration indicator (e.g., “Warranty expires in 60 days”) to prompt timely action before a coverage deadline, and asset manager 110 links the warranty-related item to warranty term records maintained in database 122.

FIG. 8 further includes assignment controls that allow a user to allocate work items to assignees (e.g., via drag-and-drop interactions) and to initiate automated assignment using an AI-driven auto-assign control. In this embodiment, asset manager 110 executes the auto-assign operation by applying classification-based routing rules, location-based workload balancing rules, and configurable priority thresholds, and asset manager 110 records resulting assignments (e.g., water leak, broken light bulb, broken sprinkler) in database 122.

Asset manager 110 also provides filtering and search controls that allow a user to view assignments across all locations or a selected location and to locate specific tasks by text query. Asset manager 110 synchronizes task assignment and status updates with alert and notification module 116 to drive user-facing notifications and with reporting and analytics module 118 to monitor workload distribution, completion status, and compliance with preventive maintenance and warranty-related requirements.

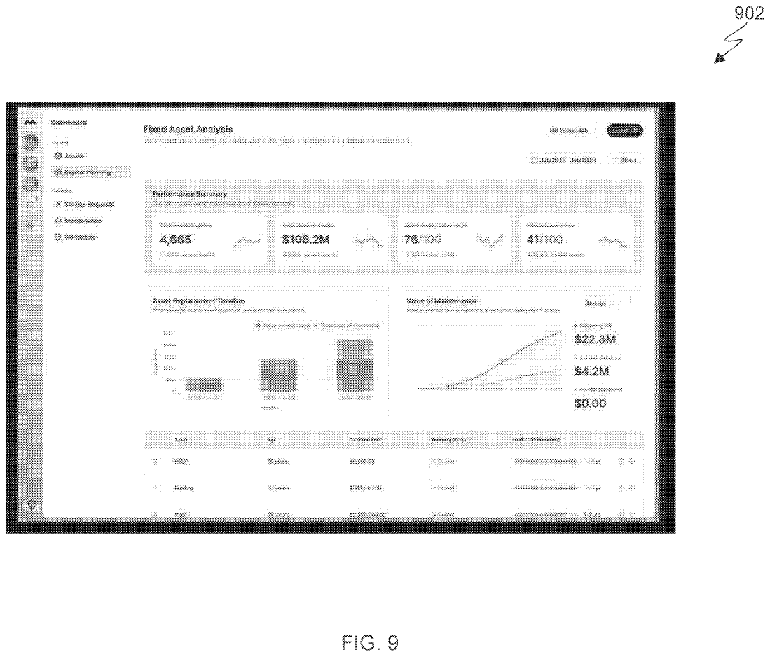

FIG. 9 is an example screenshot 902 showing a fixed asset analysis, in accordance with various embodiments of the systems and methods disclosed herein.

In particular, FIG. 9 illustrates an example capital planning and lifecycle forecasting interface 902 rendered by user interface 120 on computing device 102 (e.g., via application 104). In this embodiment, asset manager 110 configures the interface to present capital planning outputs generated by reporting and analytics module 118 using asset inventory data, maintenance history, and warranty records stored in database 122.

In FIG. 9, asset manager 110 may provide location selection and time controls (e.g., a multi-year window such as July 2026 through July 2029) and filter controls that allow a user to segment the analysis by site, asset category, warranty status, and other attributes. Asset manager 110 may also provide an export control that allows a user to export one or more reports or underlying datasets.

Asset manager 110 may display portfolio-level capital planning metrics including a total asset count, a count of assets nearing end of useful life or expiring within the selected horizon, and an aggregate value of assets. Asset manager 110 derives these metrics by combining (i) stored asset attributes (e.g., installation/substantial completion dates and purchase values), (ii) warranty status extracted by LLM-based processing engine 114, and (iii) lifecycle data and replacement cost data that LLM-based processing engine 114 retrieves through automated web searches of manufacturer and supplier sources and associates with the corresponding asset records in database 122.

FIG. 9 further includes an asset replacement timeline visualization that organizes assets by expected replacement window across the selected horizon. Asset manager 110 uses expected service life fields, end-of-life indicators, and replacement window rules maintained in database 122 to position each asset within the timeline and to support budgeting and sequencing decisions.

FIG. 9 also includes a maintenance impact visualization (i.e., Value of Maintenance) that quantifies how preventive maintenance compliance affects expected useful life and projected replacement spend. In this embodiment, asset manager 110 compares scenarios that include (i) following preventive maintenance tasks, (ii) current observed maintenance behavior reflected in completion records, and (iii) a baseline with no preventive maintenance, and asset manager 110 calculates corresponding forecasted maintenance savings and shifts in replacement timing.

Asset manager 110 may further display an asset-level list that includes, for each asset, fields such as asset age, purchase price or value, warranty status, and useful life remaining. Asset manager 110 links the asset-level list to underlying scoring outputs (e.g., asset quality index, maintenance score, and warranty score) generated by reporting and analytics module 118 to help a user prioritize candidates for repair, replacement, warranty action, and budget allocation.

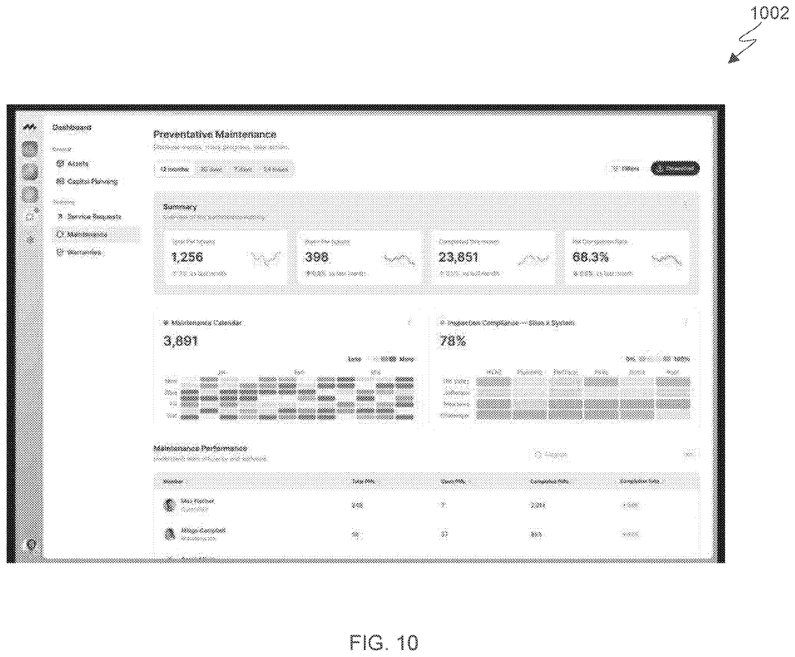

FIG. 10 is an example screenshot showing a preventive maintenance user interface, in accordance with various embodiments of the systems and methods disclosed herein.

In particular, FIG. 10 illustrates an example preventive maintenance adherence and compliance dashboard 1002 rendered by user interface 120 on computing device 102 (e.g., via application 104). In this embodiment, asset manager 110 configures FIG. 10 to present preventive maintenance (PM) performance outputs generated by reporting and analytics module 118 using standardized PM task definitions and completion records stored in database 122.

In FIG. 10, asset manager 110 may generate the underlying PM task definitions by extracting manufacturer-recommended maintenance tasks, frequencies, and triggers from ingested operating and maintenance documentation using LLM-based processing engine 114 and standardizing the extracted information into industry-standard categories (e.g., HVAC, plumbing, electrical, fire/life safety, doors, and roofing). Asset manager 110 may record the standardized tasks in database 122 and associates each task with one or more assets, locations, and assigned users or roles.

FIG. 10 may include summary metrics that quantify PM performance over a selected time window (e.g., 12 months, 30 days, 7 days, or 24 hours), including total PM tickets, open PM tickets, completed counts, and a PM completion rate. Asset manager 110 may update these metrics based on task status changes recorded in database 122 and, in some embodiments, based on acknowledgement and completion events generated through user interface 120.

FIG. 10 may further include compliance visualizations that allow a user to evaluate adherence by system type and site, including an inspection compliance visualization segmented by trade/system category, a person assigned to a maintenance task, and one or more calendar-based or time-series views that show PM workload and completion trends. Asset manager 110 computes compliance by comparing actual completion timing against required task frequencies and triggers and flags variance conditions (e.g., overdue tasks or missed inspection intervals). asset manager 110 may also include a display region to show a maintenance calendar that is color coded to different tasks needing to be completed for a respective day.

FIG. 10 also includes team performance outputs that list users and corresponding workload metrics (e.g., total PMs, open PMs, completed PMs, and completion rate). Asset manager 110 uses these outputs to support workload balancing, performance monitoring, and escalation logic, and asset manager 110 can coordinate with alert and notification module 116 to generate reminders and overdue escalations based on the compliance variances displayed in FIG. 10.

What is claimed is:

1. A computer-implemented method for context-based asset management, comprising:
monitoring, by at least one of one or more processors, a plurality of assets for compliance with asset related documentation;
detecting, by at least one of the one or more processors, a change to one or more assets of the plurality of assets that deviate from parameters associated with the asset related documentation;
in response to detecting a change to one or more assets of the plurality of assets that deviate from parameters associated with the asset related documentation, determining, by the one or more processors, options for respective assets of the plurality of assets based on the detected change; and
causing, by the one or more processors, at least one asset of the plurality of assets to change its operational behavior or performing, by the one or more processors, physical maintenance on the at least one asset of the plurality of assets based on the detected change and an analysis of the asset related documentation.

2. The computer-implemented method of claim 1, wherein asset related documentation comprises at least one of: warranties, operating manuals, maintenance manuals, invoices, receipts, or purchase orders specific to respective assets of the plurality of assets.

3. The computer-implemented method of claim 1, wherein options for respective assets of the plurality of assets based on the detected change comprise at least one of:
a recommendation to perform a maintenance task for respective assets or a recommendation identifying a replacement part for the respective assets, or an option to submit a warranty claim for the respective assets based on the detected change and an analysis of the asset related documentation, wherein the option to submit a warranty claim comprises an alert for one or more parameter conditions to satisfy the warranty claim.

4. The computer-implemented method of claim 1, further comprising:
retrieving, by the one or more processors, a warranty claim form for at least one asset of the plurality of assets; and
completing, by at least one of the one or more processors, the warranty claim form for the at least one asset of the plurality of assets based on the detected change and analysis of the asset related documentation.

5. The computer-implemented method of claim 1, further comprising:
generating, by at least one of the one or more processors, one or more training modules based on an analysis of the asset related documentation; and
rendering, by the one or more processors, the one or more training modules on an interactive graphic user interface display.

6. The computer-implemented method of claim 1, further comprising:
automatically ordering, by the one or more processors, a replacement part for at least one asset of the plurality of assets based on the detected change and an analysis of the asset related documentation.

7. The computer-implemented method of claim 1, further comprising:
generating, by the one or more processors, a graphic user interface display configured to display a representation of the plurality of assets, annotated asset related documents associated with respective assets of the plurality, one or more generated reports comprising graphical representations of warranty status for the plurality of assets, and one or more generated materials based on an analysis of the asset related documentation.

8. The computer-implemented method of claim 1, wherein monitoring the plurality of assets for compliance and detecting the change comprise:
ingesting updated asset related documentation for at least one asset via a document ingestion module;
extracting, via an LLM-based processing engine, one or more parameters from the ingested asset related documentation; and
detecting the change based on a comparison between the extracted one or more parameters and previously stored parameters associated with the asset related documentation, without relying on sensor readings from the at least one asset.

9. The computer-implemented method of claim 1, wherein determining the options for respective assets comprises:
generating preventive maintenance tasks and associated frequencies for at least one asset using an LLM-based processing engine; and
storing the preventive maintenance tasks and associated frequencies in a preventive maintenance task library that is maintained in a database indexed by at least manufacturer and model number.

10. The computer-implemented method of claim 9, wherein generating the preventive maintenance tasks comprises:
identifying, based on a manufacturer and model number of the at least one asset, a matching entry in the database comprising preventive maintenance tasks; and
retrieving the preventive maintenance tasks from the database.

11. The computer-implemented method of claim 1, further comprising:
receiving, via a user interface, a natural language query associated with a specific asset;
retrieving, using an LLM-based processing engine, one or more relevant sections of asset-specific operating and maintenance documentation associated with the specific asset; and
returning, via the user interface, a contextualized response that includes troubleshooting guidance derived from the one or more relevant sections.

12. The computer-implemented method of claim 9, further comprising:
retrieving, by the one or more processors, preventive maintenance tasks for at least one asset of the plurality of assets from the preventive maintenance task library based on a manufacturer name and model number associated with the at least one asset.

13. The computer-implemented method of claim 1, further comprising:
receiving, by the one or more processors, a natural language troubleshooting query from a user associated with at least one asset of the plurality of assets via a graphical user interface;
identifying, by the one or more processors using retrieval-augmented generation, one or more relevant sections of asset related documentation stored on one or more computer readable storage media that correspond to the natural language troubleshooting query; and
rendering, by the one or more processors, a structured troubleshooting response on the graphical user interface comprising probable causes, affected components, and recommended corrective steps derived from the identified one or more relevant sections of asset related documentation.

14. The computer-implemented method of claim 1, further comprising:
assigning, by the one or more processors using an LLM-based processing engine, at least one asset of the plurality of assets to one or more industry-standard construction classification codes comprising a CSI MasterFormat division code and a UniFormat classification code based on an analysis of asset related documentation associated with the at least one asset; and
automatically routing, by the one or more processors, one or more preventive maintenance tasks associated with the at least one asset to a technician based on the assigned CSI MasterFormat division code and one or more configurable permission rules associated with the technician.

15. A computer program product for context-based asset management, comprising:
one or more computer readable storage media and program instructions stored on the one or more computer readable storage media, the program instructions comprising:
program instructions to monitor a plurality of assets for compliance with asset related documentation;
program instructions to detect a change to one or more assets of the plurality of assets that deviate from parameters associated with the asset related documentation;
program instructions to, in response to detecting a change to one or more assets of the plurality of assets that deviate from parameters associated with the asset related documentation, determine options for respective assets of the plurality of assets based on the detected change; and
program instructions to cause at least one asset of the plurality of assets to change its operational behavior or perform physical maintenance on the at least one asset of the plurality of assets based on the detected change and an analysis of the asset related documentation.

16. The computer program product of claim 15, wherein asset related documentation comprises: warranties, operating manuals, maintenance manuals, invoices, receipts, and purchase orders specific to respective assets of the plurality of assets.

17. The computer program product of claim 15, wherein options for respective assets of the plurality of assets based on the detected change comprise at least one of:
a recommendation to perform a maintenance task for respective assets, a replacement part for the respective assets, or an option to submit a warranty claim for the respective assets based on the detected change and an analysis of the asset related documentation, wherein the option to submit a warranty claim comprises an alert for upcoming warranty expiration dates and parameter conditions to satisfy the warranty claim.

18. The computer program product of claim 15, wherein the program instructions stored on the one or more computer readable storage media further comprise:
program instructions to retrieve a warranty claim form for at least one asset of the plurality of assets; and
program instructions to complete the warranty claim form for the at least one asset of the plurality of assets based on the detected change and analysis of the asset related documentation.

19. A computer system for context-based asset management, comprising:
one or more computer processors;
one or more computer readable storage media; and
program instructions stored on the one or more computer readable storage media for execution by at least one of the one or more computer processors, the program instructions comprising:
program instructions to monitor a plurality of assets for compliance with asset related documentation;
program instructions to detect a change to one or more assets of the plurality of assets that deviate from parameters associated with the asset related documentation;
program instructions to, in response to detecting a change to one or more assets of the plurality of assets that deviate from parameters associated with the asset related documentation, determine options for respective assets of the plurality of assets based on the detected change; and
program instructions to cause at least one asset of the plurality of assets to change its operational behavior or perform physical maintenance on the at least one asset of the plurality of assets based on the detected change and an analysis of the asset related documentation.

20. The computer system of claim 19, wherein the program instructions stored on the one or more computer readable storage media further comprise:
program instructions to receive, via a mobile application associated with the one or more processors, a captured image of a manufacturer equipment placard affixed to at least one asset of the plurality of assets;
program instructions to apply prompt-engineered optical character recognition processing to the captured image to extract asset identification information comprising at least a manufacturer name and a model number; and
program instructions to initiate an automated web search using the extracted asset identification information to retrieve manufacturer-specific operations and maintenance documentation associated with the at least one asset and ingest the retrieved documentation into the one or more computer readable storage media for processing by the one or more processors.
